(19) United States
(12) Patent Application Publication
(10) Pub. No.: US 2005/0119144 A1
(43) Pub. Date: Jun. 2, 2005

(54) Method of cleaning with demineralized water and composition therefor

(76) Inventors: Keith Kennedy, Lebanon, OH (US); Jacques Rouillard, Loveland, OH (US)

Correspondence Address: WOOD, HERRON & EVANS, LLP, 2700 CAREW TOWER, 441 VINE STREET, CINCINNATI, OH, 45202, US

(21) Appl. No.: 10/974,266

(22) Filed: Oct. 27, 2004

Related U.S. Application Data
(60) Provisional application No. 60/514,963, filed on Oct. 28, 2003.

(51) Int. Cl. C11D 1/00

(52) U.S. Cl. 510/218

(57) ABSTRACT

Food processing equipment is cleaned with an aqueous detergent composition wherein the water in the cleaning composition is demineralized. This is combined with concentrated detergent and applied at an elevated temperature to the walls of the food processing equipment. The detergent composition has sufficient sequesterant to remove 100% to 110% of any calcium or magnesium ions released from soil that is removed from the surface of the processing equipment, generally an amount effective to remove from about 10 to about 35 parts per million hardness ions.

### RELATED APPLICATION

This application is a regular utility application which is related to U.S. Provisional Patent Application Ser. No. 60/514,963, filed on Oct. 28, 2003. The entire disclosure of this application is incorporated herein by reference.

### BACKGROUND OF THE INVENTION

Food processing plants as well as food transportation equipment, i.e., tankers, must be cleaned on a regular basis using a clean-in-place wash system. The solution used to clean the food processing plants and tankers are typically 95-99.9% water, with the balance of the wash water composition consisting of food soils and alkaline detergents. The detergents used in the wash step are usually selected based on the soil being removed and on the quality of the water being used for cleaning.

These detergents generally include three major components. Caustic is present in an amount effective to establish a pH of at least 12 in order to remove fat; a source of chlorine is added, generally sodium hypochlorite, in order to remove protein; and, finally, a water conditioner is added to deal with water hardness, magnesium and calcium ions in particular.

In these clean-in-place wash systems there are three sources of dissolved solids or hardness ions. The primary source is the water used for cleaning. The water is usually obtained from a well located at the processing plant or from the local municipality. Water quality varies widely, based on geographic location. The food soils picked up by the equipment during the cleaning process are also a source of dissolved solids. As food soils are removed from the equipment they are dissolved and suspended in the wash water. The soils can include denatured proteins, fats, carbohydrates and minerals, such as calcium. Finally, the detergent itself is a source of dissolved solids.

Typically in these systems, the equipment is initially pre-rinsed with city or well water without additives. This usually lasts 15 to 600 seconds, depending upon the item being cleaned. This is followed by an alkaline wash, in which an alkaline detergent is added to the wash water which is recirculated for 5 to 120 minutes at elevated temperatures, usually from 130° F. to 180° F.

Precipitated minerals in the wash water pose a major problem. Over time, a visible mineral film will start to form on the process equipment. As a result, the mineral films must be prevented from forming through the use of water-conditioning agents such as AMP, HEDP, EDTA, NTA, IDA, gluconate, and polyacrylic acid and salts (MW 3,000-10,000) and the inorganic polyphosphates. The alkaline wash is followed by a free water rinse and a sanitizer application.

Although soft water has been used in the food processing industries in the past, the usual practice is simply to decrease the amount of alkaline detergent that is used during the alkaline wash. However, this has its limitations. Soft water significantly reduces the need for water conditioners. It also reduces the alkalinity requirement somewhat, but it does not reduce the hypochlorite ion requirement.

The concentration of hypochlorite ion required to remove protein establishes the minimum effective concentration of the detergent formulation that can be used. Even with this minimum effective concentration, the wash water will contain excess water conditioners which, in effect, will unduly raise the cost of cleaning the equipment. On the other hand, it is impossible to formulate an effective detergent formulation without the presence of water conditioners. As indicated, these water conditioners are required to address other sources of hardness, such as the soil that is being washed and, of course, the detergent formulation itself.

### SUMMARY OF THE INVENTION

Accordingly, it is an object of the present invention to provide a method of cleaning food processing and transporting equipment by applying to the surface of the equipment a wash solution formed from demineralized water having a total hardness less than about 30 ppm, and preferably 1-3 ppm, or less, in combination with a source of alkalinity in an amount effective to establish the pH of the wash water to about 12 or higher, an amount of hypochlorite ion effective to establish a hypochlorite concentration of 60-150 ppm (160 to 290 ppm for a re-use system), and an amount of water conditioner effective to sequester hardness ions from the soil contained on the surface being washed but no more than an amount effective to sequester approximately 110% of the hardness ions from the soil on the equipment being washed.

The amount of water conditioner will vary depending upon the particular cleaning operation. Equipment can be cleaned with a single-use application where the water is discharged after a single piece of equipment is cleaned. Other operations are multiple-use operations where the cleaning solution is used to clean multiple pieces of equipment. This is particularly useful in cleaning tankers where multiple tankers can be cleaned with the same wash water before it is discarded.

The invention will be further appreciated in light of the following detailed description.

### BRIEF DESCRIPTION OF THE DRAWINGS

FIG. 1 is a graph depicting calcium concentration in a single-use truck wash;

FIG. 2 is a graphical representation of calcium concentration of a re-use wash system.

### DETAILED DESCRIPTION OF THE INVENTION

According to the present invention, food processing and transporting equipment is washed with a hot aqueous solution containing a source of alkalinity, a source of hypochlorite ion, and an effective amount of water conditioner.

The water used to formulate the cleaning solution is first demineralized using standard equipment such as a water softener. The water should contain less than 30 ppm, and preferably 10 ppm or less, and most preferably no more than 1-3 ppm, total calcium and magnesium.

For use in the present invention, the alkalinity source will be sufficient to establish a pH of from about 12 to about 14, with 12 to 13 being preferred. The preferred source of alkalinity is sodium hydroxide, due to cost. Other alkalinity sources include potassium hydroxide carbonates, silicates and phosphates. The purpose of the sodium hydroxide is to provide dispersion and remove fat.

The second component of the detergent for use in the present invention is a source of hypochlorite ion. Normally sodium hypochlorite is used. The purpose of the sodium hypochlorite is to remove protein present in the soil. This generally requires a concentration of hypochlorite ion of about 90 to about 290 ppm, with 100 being preferred. These numbers vary based on the type of equipment used, i.e., single versus multiple use.

The final component of the present invention is a water conditioner. The water conditioner is typically one of a variety of different compositions. These include AMP, HEDP, EDTA, NTA, gluconates, polyacrylic acid and salts, as well as other water soluble polymers and the polyphosphates. Preferred water conditioners include, but are not limited to, water soluble polyacrylates and polymethacrylates. Generally, these would have a molecular weight of from about 1500 to about 10,000. Also, acrylate, methacrylate and acrylamide copolymers and terpolymers can be used. The concentration of the water conditioner is based on the use of the product, in other words, the soil being removed, which is discussed further below.

The detergent may further include various other components such as stabilizing agents including, but not limited to, sucrose, corrosion inhibitors, such as, but not limited to, sodium silicate, which also may have an effect upon sequestering hardness ions, but is primarily useful as an antioxidant, as well as a suspending agent for dissolved solids and a lifting agent for oils.

According to the present invention, prior to application, the wash water is softened to remove virtually all hardness ions generally less than 10 ppm and, most likely, less than 1 ppm. Therefore, the amount of sequestering agent or water conditioner will be dependent primarily upon the soil on the processing equipment. For example, if the soil is heavy cream, it will require more water conditioner than if the soil is milk or a low-fat milk product. Also, the amount will be less for a single-use system than for a re-use system.

The amount of water conditioner required in the formulation of the present invention can be defined in terms of the amount required to remove a defined level of hardness ions which will be present in the wash system. In terms of formulation, this can be defined in terms of the ratio of the amount of alkaline source to the amount of water conditioner necessary to remove a defined amount of calcium ions. Likewise, this can be defined in terms of the ratio of hypochlorite source to water conditioner necessary to remove a defined level, in terms of parts per million, of calcium ions. Thus, for a detergent designed to clean a single tanker which had carried heavy cream, the ratio of sodium hydroxide to water conditioner can be stated as 590 ppm sodium hydroxide to 22 ppm calcium sequestration. Thus, the detergent would require sufficient water conditioner to remove that defined level of hardness. This is important since many of the water conditioners sequester more than one ion of calcium per molecule of water conditioner. Likewise, the ratio for a single-use cleaning of a tanker that is carrying milk would be about 354 ppm sodium hydroxide to 13 ppm calcium sequestration, and 90 ppm sodium hypochlorite. For a low-fat milk product, the ratio would be 165 ppm sodium hydroxide to 13 ppm calcium sequestration and 100 ppm sodium hypochlorite to 13 ppm calcium sequestration.

For a re-use system, the desired concentration should be, for cream, 600 ppm sodium hydroxide to 45 ppm calcium sequestration; 240 ppm sodium hypochlorite to 45 ppm calcium sequestration. For milk, the ratio would be 885 ppm sodium hydroxide to 33 ppm calcium sequestration, 225 ppm sodium hypochlorite to 33 ppm calcium sequestration. And for a low-fat product, approximately 400 ppm sodium hydroxide to 31 ppm calcium sequestration, 160 ppm sodium hypochlorite. Thus, this invention defines the amount of water conditioner in the detergent based on the amount of calcium that must be sequestered by the water conditioner.

Prior to formulating the washing solution, i.e., the water with the detergent, the water is softened to less than 30 ppm, preferably less than 1 ppm, of hardness ions. This is then combined with the detergent composition to establish the following concentrations: sodium hydroxide 0.05%, sodium hypochlorite 0.015%, and water conditioner in an amount effective to remove the desired concentration of calcium ions from the wash water. This is heated to a temperature of approximately 130 to 180° F., and sprayed onto the surface of the food processing equipment. The wash solution is recirculated through the equipment for a period of time until the equipment is effectively cleaned, generally 4 to 180 minutes.

In a re-use system, this would be sprayed into, for example, a tanker, for a period of time effective to clean the inside of the tanker. The water would be reclaimed and re-used in the next tanker. This can be repeated for a number of times based on the effective concentration of the detergent.

Evaluation of the amount of sequesterant needed for particular soils can be determined empirically. In particular, tests were conducted in both a single-use tanker wash and a re-use system to wash tankers that had been previously filled with milk. In each case, the processor was using water for the alkaline wash step and an alkaline post-rinse which was softened to a hardness of less than 1 grain per gallon. This was used with a commercially available detergent.

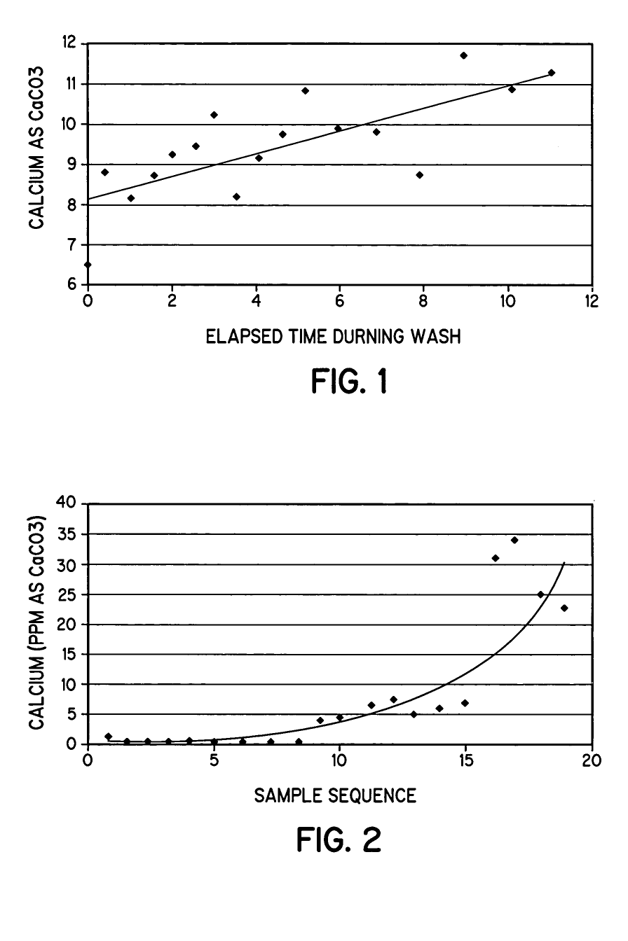

The first data set shows calcium levels building in a single-use tanker clean-in-place system. As the tanker is washed, milk soil is removed from the sides of the tank and placed into solution. The calcium concentration from the soil increases during the wash as successively higher levels of soil are removed from the stainless steel surface to the wash water. The rising calcium concentration is shown in FIG. 1. The feature of interest is the maximum calcium concentration at the end of the wash, about 11 ppm. This is the level of hardness that the detergent must successfully complex to avoid mineral film build-up in the tanker. It is also noteworthy that the calcium level is substantially lower than that found in a typical 10 grain water, which would be about 190 ppm hardness.

It follows that a detergent designed for specific soils in this example would have significantly less water conditioner than those selected base on water chemistry. In particular, for use in the present invention, the appropriate sequesterant would be used in a concentration effective to sequester at least 11 ppm calcium and, preferably, about 10% in excess of this, for safety margin.

As shown in FIG. 2, the same methodology may be used for a tanker clean-in-place re-use system. In this example, nineteen tankers were washed. As shown in FIG. 2, the calcium levels build slowly, with some calcium uptake from each truck. In a re-use system, there is also some fresh water loss and fresh water replacement with each successive cycle. Here the calcium level slowly builds to a final concentration of about 25 ppm at which point the clean-in-place system is dumped and replaced with fresh solution. In this case, the product must again be designed to anticipate and successfully complex the calcium that builds in the wash water. The primary calcium source is from milk soils and, in this case, the level was 25-30 ppm. Thus, an amount of sequesterant must be employed that will sequester at least 25-30 ppm and, preferably, approximately 10% more than this, for safety purposes.

The table below shows the preferred ranges of caustic chelant and hypochlorite in the wash solutions for single and re-use systems for skim milk, whole milk and cream.

TABLE

| | Skim Milk | PPM | Whole Milk | PPM | Cream | PPM |
|---|---|---|---|---|---|---|
| Single-Use | Sodium Hydroxide | 350-425 | Sodium Hydroxide | 350-425 | Sodium Hydroxide | 590-710 |
| | Chelant | 10-20 | Chelant | 10-20 | Chelant | 20-30 |
| | Chlorine | 90-110 | Chlorine | 90-110 | Chlorine | 200-240 |
| Re-Use | Sodium Hydroxide | 400-480 | Sodium Hydroxide | 885-1060 | Sodium Hydroxide | 600-720 |
| | Chelant | 30-40 | Chelant | 30-40 | Chelant | 45-55 |
| | Chlorine | 160-195 | Chlorine | 225-270 | Chlorine | 240-290 |

Skim Milk: Less than .5% milk fat
Whole Mile: Greater than 3% to less than 10.5% milk fat
Cream: Greater than 10.5% milk fat, generally 30% to 40%

The formulations of the present invention are most notable for the fact that there are relatively low amounts of sequesterant. As the sequesterant is the most expensive part of the detergent formulation, reducing the sequesterant has the greatest affect on cost. Thus, in practicing the present invention, the same cleaning efficiency is achieved at substantially lower costs, regardless of locality and the quality of the water source.

Although the above formulations relate to cleaning dairy equipment, the same methodology can be used for any type of soil. One simply needs to determine the hardness contributed by the soil and adjust the detergent formulation to sequester 100% to about 110% of the hardness ions.

This has been a description of the present invention along with the preferred method of practicing the invention. However, the invention itself should only be defined by the following claims, WHEREIN WE CLAIM:

1. A method of cleaning food processing equipment with an aqueous-based detergent comprising forming a washing solution by softening water;
adding to said water at least about 60 parts per million —OCI ion;
adding to said water an effective amount of alkalinity to establish a pH of said solution of at least 12;
adding to said water an amount of sequestering agent effective to sequester 100 to 110% of hardness ions released by soil removed from the surface of said food equipment during cleaning;
spraying said washing solution on said food equipment for a time effective to clean said equipment.

2. The method claimed in claim 1 wherein the concentration of hypochlorite ion is at least about 90 parts per million.

3. The method claimed in claim 2 wherein the amount of alkalinity is at least about 165 parts per million sodium hydroxide.

4. A method of cleaning cream having at least 10.5% milk fat from the walls of a tank utilizing a system wherein a plurality of tanks are washed with the same wash solution comprising
forming a wash solution by combining softened water with a detergent composition effective to establish the following use concentrations: —OCI 240 to 290 ppm; —OH greater than 600 ppm; and an amount of a sequestering agent effective to sequester 45 to about 55 ppm calcium ions.

5. A method of cleaning milk having at least 3 to less than 10.5% milk fat from the walls of a tank utilizing a system wherein a plurality of tanks are washed in the same wash solution comprising
forming a wash solution by combining softened water with a detergent composition effective to establish the following use concentrations: —OCI 225 to 270 ppm; —OH greater than 885 ppm; and an amount of a sequestering agent effective to sequester about 30 to about 40 ppm calcium ions.

6. A method of cleaning low-fat milk having less than 0.5% milk fat from the walls of a tank utilizing a system wherein a plurality of tanks are washed in the same wash solution comprising
forming a wash solution by combining softened water with a detergent composition effective to establish the following use concentrations: —OCI 160 to about 195 ppm; —OH greater than 400 ppm; and an amount of a sequestering agent effective to sequester about 30 to about 40 ppm calcium ions.

7. A method of cleaning cream having greater than 10.5% milk fat from the walls of a tank in a single-use system by spraying onto said walls of said tank a cleaning solution and subsequently discharging said cleaning solution after a single use wherein said wash solution comprises deionized water and 200 to 240 ppm —OCI; at least 590 to 710 ppm —OH; and an amount of a sequestering agent effective to sequester about 20 to about 30 ppm calcium in said wash solution.

8. A method of cleaning milk having 0.5 to 4% milk fat from the walls of a tank in a single-use system by spraying onto said walls of said tank a cleaning solution and subsequently discharging said cleaning solution after a single use wherein said wash solution comprises deionized water and 90 to 110 ppm —OCI; at least 350 ppm —OH; and an amount of a sequestering agent effective to sequester about 10 to about 20 ppm calcium in said wash solution.

9. A method of cleaning low-fat milk having less than 0.5% milk fat from the walls of a tank in a single-use system by spraying onto said walls of said tank a cleaning solution and subsequently discharging said cleaning solution after a single use wherein said wash solution comprises deionized water and 90 to 110 ppm —OCI; at least 350 ppm —OH; and an amount of a sequestering agent effective to sequester about 10 to about 26 ppm calcium in said wash solution.
